(19) United States
(12) Patent Application Publication
(10) Pub. No.: US 2022/0351128 A1
(43) Pub. Date: Nov. 3, 2022

(54) ELECTRONIC SYSTEMS, METHODS, AND APPARATUSES FOR FACILITATING MANAGEMENT OF PACKAGE DELIVERIES

(71) Applicant: Tariq Hameed, Woodbridge, VA (US)

(72) Inventor: Tariq Hameed, Woodbridge, VA (US)

(21) Appl. No.: 17/661,547

(22) Filed: Apr. 29, 2022

Related U.S. Application Data
(60) Provisional application No. 63/181,841, filed on Apr. 29, 2021.

(51) Int. Cl. G06Q 10/08

(52) U.S. Cl. CPC G06Q 10/0833; G06Q 10/0832

(57) ABSTRACT

An example operation includes instructing a sorting center device associated with a package sorting center to send a package collecting notification to a driver device associated with a delivery driver. The package collecting notification includes a package identifier that uniquely identifies the package. The package identifier is associated with a customer identifier. The package is located using the driver device or the sorting center device. A package unloading notification is received from the driver device or a drive-through store device. The unloading notification includes the package identifier. A package availability notification is generated based on the package unloading notification. The availability notification is transmitted to a customer device. The customer identifier is received from the customer device. The customer is authenticated. The package is identified based upon the package identifier and the authenticating.

### CROSS REFERENCE TO RELATED APPLICATIONS

The present application claims the benefit of the filing date of U.S. Provisional Patent Application Ser. No. 63/181,841, filed on Apr. 29, 2021, the disclosure of which is incorporated herein by reference in its entirety.

### BACKGROUND

The present invention relates generally to the field of electronic data processing. More specifically, the present invention relates to electronic systems, methods, and apparatuses for facilitating management of package deliveries.

### SUMMARY

Existing techniques for electronically managing package deliveries are deficient with regard to several aspects. For instance, current technologies are not adequately tailored to address scenarios where packages are delivered using drive-through stores or curbside deliveries, or where packages are transported from a storage and distribution center to at least one drive-through store.

One example embodiment provides a method that includes at least one of: receiving an arrival notification from a driver device associated with a delivery driver; generating a driver identification request based on the arrival notification; transmitting the driver identification request to the driver device; receiving a driver identifier associated with the driver from the driver device; authenticating the driver based on the driver identifier; instructing a sorting center device associated with a package sorting center to send a package collecting notification to the driver device, the package collecting notification including a package identifier uniquely identifying a package, wherein the package identifier is associated with a customer identifier uniquely identifying a customer; identifying the package using at least one of the driver device or the sorting center device, based on the package identifier; receiving a package unloading notification including the package identifier from at least one of the driver device or a drive-through store device associated with a drive-through store; generating a package availability notification including the package identifier based on the package unloading notification; transmitting the package availability notification to a customer device associated with the customer; receiving a customer identifier uniquely identifying the customer from the customer device; authenticating the customer based on the customer identifier; and identifying the package at the drive-through store based upon the package identifier and the authenticating of the customer.

Another example embodiment provides a system that includes a centralized server operatively coupled to a computer-readable storage medium; a communication network communicably coupled to the centralized server; a driver device associated with a delivery driver and communicably coupled to the communication network; a sorting center device associated with a delivery sorting center and communicably coupled to the communication network; a drive-through store device associated with a drive-through store and communicably coupled to the communication network; a customer device associated with a customer and communicably coupled to the communication network; and a management center communication device operatively coupled to the communication network; the management center communication device configured for receiving an arrival notification from the driver device; the centralized server configured for generating a driver identification request for the delivery driver based on the arrival notification; the management center communication device further configured for transmitting the driver identification request to the driver device, and receiving a driver identifier associated with the delivery driver from the driver device; the centralized server further configured for authenticating the driver based on the driver identifier; the management center communication device further configured for receiving a package collecting notification including a package identifier that uniquely identifies a package from the sorting center device, wherein the package identifier is associated with a customer identifier in the computer-readable storage medium, the customer identifier uniquely identifying a customer; the centralized server further configured for identifying a package based on the package identifier; the management center communication device further configured for receiving a package unloading notification from the drive-through store device; the centralized server further configured for generating a package availability notification including the package identifier based on the package unloading notification; the management center communication device further configured for transmitting the package availability notification to the customer device and receiving a customer identifier uniquely identifying the customer from the customer device; and the centralized server further configured for authenticating the customer based on the customer identifier. At least one of the centralized server, the drive-through store device, or the customer device is configured for identifying the package at the drive-through store based on the package identifier and the authenticating of the customer.

A further example embodiment provides a computer readable storage medium comprising instructions that, when read by a processor, cause the processor to perform at least one of: receiving an arrival notification from a driver device associated with a delivery driver; generating a driver identification request based on the arrival notification; transmitting the driver identification request to the driver device; receiving a driver identifier associated with the driver from the driver device; authenticating the driver based on the driver identifier; instructing a sorting center device associated with a package sorting center to send a package collecting notification to the driver device, the package collecting notification including a package identifier for uniquely identifying a package, wherein the package identifier is associated with a customer identifier for uniquely identifying a customer; identifying the package using at least one of the driver device or the sorting center device, based on the package identifier; receiving a package unloading notification including the package identifier from at least one of the driver device or a drive-through store device associated with a drive-through store; generating a package availability notification including the package identifier based on the package unloading notification; transmitting the package availability notification to a customer device associated with the customer; receiving a customer identifier uniquely identifying the customer from the customer device; authenticating the customer based on the customer identifier; and identifying the package associated with the customer based on the package identifier and the authenticating of the customer.

This summary is provided to introduce a selection of concepts in a simplified form. These concepts are further described below in the Detailed Description. This summary may not necessarily identify all key features or essential features of the claimed subject matter. Nor is this summary intended to be used to limit the scope of the claimed subject matter. Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings may contain representations of various trademarks and copyrights owned by the Applicants. In addition, the drawings may contain other marks owned by third parties and, as such, are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose. Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online hardware platform consistent with various embodiments of the present disclosure.

FIG. 2 is a flowchart of a method for facilitating the management of package deliveries, in accordance with some embodiments.

FIG. 3 illustrates sending of an arrival notification from a device associated with a delivery driver for facilitating the management of package deliveries, in accordance with some embodiments.

FIG. 4 illustrates verification of a driver by a controller at a sorting center for facilitating the management of package deliveries, in accordance with some embodiments.

FIG. 5 illustrates scanning of a barcode on a screen monitor of the sorting center for facilitating the managing of package deliveries, in accordance with some embodiments.

FIG. 6 illustrates a loading process for facilitating the management of package deliveries, in accordance with some embodiments.

FIG. 7 illustrates a procedure for arranging the packages in the sorting center for facilitating the managing of package deliveries, in accordance with some embodiments.

FIG. 8 illustrates exemplary package labels for facilitating the management of package deliveries, in accordance with some embodiments.

FIG. 9 illustrates a package loading procedure for facilitating the management of package deliveries, in accordance with some embodiments.

FIG. 10 illustrates a package loading procedure for facilitating the management of package deliveries, in accordance with some embodiments.

FIG. 11 illustrates a package unloading procedure at a drive-through store for facilitating the management of package deliveries, in accordance with some embodiments.

FIG. 12 illustrates a package unloading procedure at a vehicle to facilitate the management of package deliveries, in accordance with some embodiments.

FIG. 13 illustrates a package scanning, signing, and arrangement procedure at the drive-through store for facilitating the management of package deliveries, in accordance with some embodiments.

FIG. 14 illustrates transmitting of a notification to customers for facilitating the management of package deliveries, in accordance with some embodiments.

FIG. 15 illustrates a package arrangement procedure at the drive-through store for facilitating the management of package deliveries, in accordance with some embodiments.

FIG. 16 illustrates customer and driver pickup procedures from the drive-through store for facilitating the management of package deliveries, in accordance with some embodiments.

FIG. 17 illustrates a package pickup and drop off procedure from the drive-through store for facilitating the management of package deliveries, in accordance with some embodiments.

FIG. 18 illustrates printing of a receipt for facilitating the management of package deliveries, in accordance with some embodiments.

FIG. 19 illustrates locating one or more packages placed in the drive-through store for facilitating the management of package deliveries, in accordance with some embodiments.

FIG. 20 illustrates a procedure for handing packages off to drivers and customers for facilitating the management of package deliveries, in accordance with some embodiments.

FIG. 21 illustrates placement of sorting centers and drive-through stores around the world for facilitating the management of package deliveries, in accordance with some embodiments.

FIG. 22 is a block diagram of a computing device for implementing the methods disclosed herein, in accordance with some embodiments.

### DETAILED DESCRIPTION

It will be readily understood that the instant components, as generally described and illustrated in the figures herein, may be arranged and designed in a wide variety of different configurations. Thus, the following detailed description of the embodiments of at least one of a method, apparatus, computer readable storage medium and system, as represented in the attached figures, is not intended to limit the scope of the application as claimed but is merely representative of selected embodiments. Multiple embodiments depicted herein are not intended to limit the scope of the solution. The computer-readable storage medium may be a non-transitory computer readable medium or a non-transitory computer readable storage medium.

In some embodiments, the customer device, the driver device, the sorting center device, the drive-through store device, the management communication device and the centralized server may each be implemented using, for example, one or more smartphones, personal computers, laptop computers, tablet devices, processing devices, or the like. Communications between these devices between may be sent and/or received, and processed by one or more ‘components’ which may be hardware, firmware, software or a combination thereof. The components may be part of any of these entities or computing devices or certain other computing devices.

The instant features, structures, or characteristics as described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one example. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments. In the diagrams, any connection between elements can permit one-way and/or two-way communication even if the depicted connection is a one-way or two-way arrow.

It will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail. Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

The present disclosure contains headings. It should be understood that these headings are used as references and are not to be construed as limiting upon the subjected matter disclosed under the heading. The present disclosure includes many aspects and features. Moreover, while many aspects and features relate to, and are described in the context of systems, methods, apparatuses and devices for facilitating the management of package deliveries, embodiments of the present disclosure are not limited to use only in this context.

In overview, the present disclosure describes systems, methods, and apparatuses for facilitating the management of package deliveries. Further, the present disclosure describes package delivery procedures for delivering packages from the sorting center to the drive-through store. The driver arrives at the sorting center to pick up a package and transmits an arrival notification to the centralized server from an application on the driver device. Further, the present disclosure describes generating a package pickup schedule for scheduling a pickup of a package by the driver. The package is associated with a corresponding package identifier. The centralized server associates the package identifier with a customer identifier uniquely identifying a customer for the package. The centralized server performs a driver identification verification procedure on behalf of the sorting center. Further, when the driver arrives at the sorting center to pick up a package, the driver identification as well as a locker number specifying a temporary storage location for the package are both verified by the centralized server, optionally using the package pickup schedule. Further, the present disclosure describes the package pickup schedule and package locker procedures. Further, after checking and verification by the processing device, the driver scans a package barcode on the driver device to specify the locker number and the package identifier, optionally based on the schedule.

Further, the present disclosure describes delivery driver pickup procedures from the package locker at the sorting center. Further, once the driver parks a vehicle in front of a locker parking space, the package locker door will open and the package loading process may begin. Further, the present disclosure describes package arranging procedures at the sorting center. Further, the packages are arranged in a form at the sorting center and then are distributed to the drive-through store. Further, the packages may include package labels. Further, the package labels may include: a) a box sticker that provides the weight of the package, the package identifier, a shipping date and time, a complete destination address, and a package barcode; b) a drive-through store identifier specifying what drive-through store is assigned to the package, wherein the store identifier could be a number, alphanumeric code, or barcode; and c) a color tag provided in any of a plurality of different colors, where each specific color determines a type or category for the package.

Further, the present disclosure describes a procedure by which the driver unloads the package at the sorting center, followed by the customer loading the package from the sorting center. The present disclosure describes an unloading procedure for the drive-through store. Further, the unloading procedure may include scanning the arrival barcode on at least one of the driver device, the sorting center device, or the drive-through store device, which is located at an unloading area. Further, the unloading procedure may include opening the locker door and signing in the packages to the package locker at the drive-through store. Further, the present disclosure may include unloading procedures. Further, when the driver unloads the package in the locker, the package will automatically sign in to the drive-through store.

Further, the present disclosure describes package scanning, signing, and arrangement procedures at the drive-through store. Further, a drive-through store employee starts scanning the packages from an unloading area and arranges them to the shelf based on the type of the packages, and at the same time sends a notification to the customer device to let the customer know that the package is available at a designated drive-through store located at a specified geographic location. For example, a plurality of drive-through stores may be provided throughout a city, state, county, or metropolitan area. Further, the present disclosure describes package arrangement procedures at the drive-through store. The drive-through store can be designed with one or more shelves. The shelves can be divided into a plurality of individual sections, with each section of the shelves being designated for different types of packages.

Further, the present disclosure describes customer and driver package pickup procedures from the drive-through store. Further, when drivers and customers arrive at the drive-through store they may select an arrival button on the customer device, illustratively using an application running on the customer device. In some embodiments, drivers only drop off packages at the drive-through store, whereas customers only pick up packages from the drive-through store. Further, the present disclosure describes package pickup and drop off procedures at the drive-through store. Further, as soon as the driver and customer give the package identifier to a drive-through store employee or scan a barcode on the package, an automatic printer may print a receipt bearing a bar code. Further, when the receipt is printed from the printer, the drive-through store employee scans the barcode on the receipt to find out the location of the package. Further, a drive-through store employee will then find the package based on the barcode or number, and place it at a customer pickup location at the drive-through store before the customer arrives at the drive-through store. After the verification of the package identifier and customer identifier (for example, a driver's license ID) from the driver, the drive-through store employee scans the package and gives the package to the customer. Further, the present disclosure describes package drive-through store delivery procedures. Further, the packages are sorted at the sorting center first and are then transported by the delivery driver to the drive-through store for delivery to the customer.

Further, the present disclosure describes the methods, the systems, and the apparatuses that accomplish delivery, pickup, and drop-off of the package from the drive-through store anywhere and at any time. Further, the present disclosure describes the methods, the systems, and the apparatuses that form a connection point between the customers and online logistic companies to reduce the distance and transit time for package deliveries. Packages may be picked up and drop off at the same location, 24 hours a day, and package delivery service may be provided to every part of a city or village. Further, the present disclosure describes the methods, the systems, the apparatuses, and the devices that are capable of providing 24-hour delivery service for any online logistics company located anywhere, providing career opportunities, as well as accelerating the speed of delivery safely and securely. Meanwhile, the customer is able to send and receive packages conveniently and expeditiously.

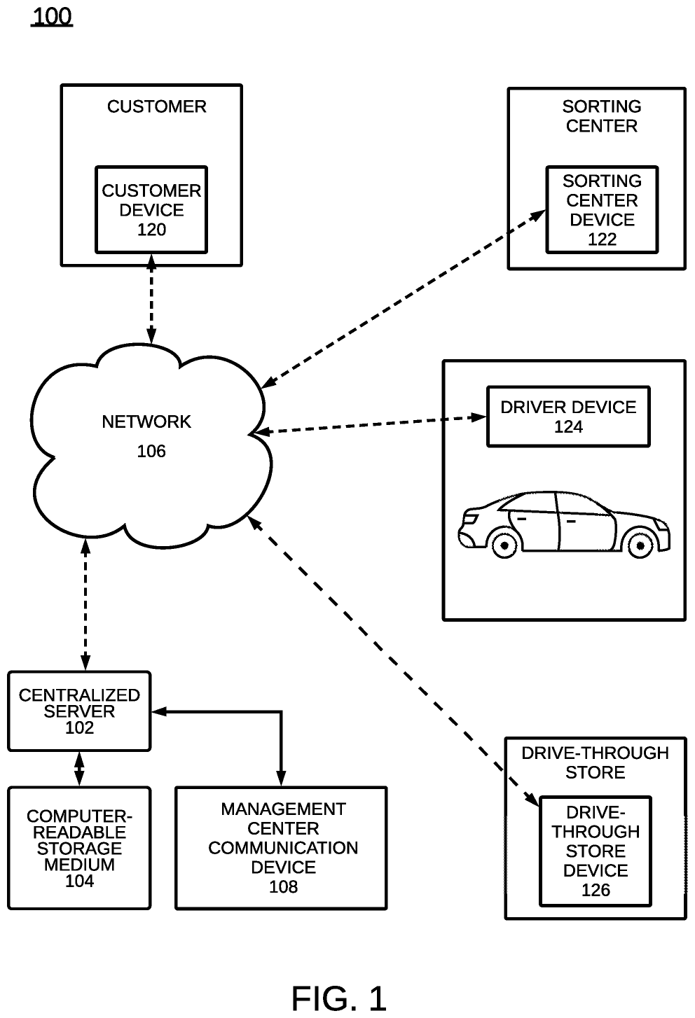

FIG. 1 is an illustration of an online platform 100 consistent with various embodiments of the present disclosure. By way of non-limiting example, the online platform 100 to facilitate managing deliveries of packages may be hosted on a processing device such as a centralized server 102. In some embodiments, the centralized server 102 is a cloud computing service. The online platform 100 also includes a computer-readable storage medium 104 that is operatively coupled to the centralized server 102. A communications network 106 is communicably coupled to the centralized server 102. In some embodiments, the communications network 106 is the Internet, a cellular network, a network of radio transceivers, or any of various combinations thereof.

A driver device 124 is associated with a delivery driver and communicably coupled to the communications network 106. In some embodiments, the driver device 124 is a handheld device, a smartphone, a tablet device, a computer device, a radio transceiver, a laptop computer, a desktop computer, a smartwatch, or any of various combinations thereof. A sorting center device 122 is associated with a delivery sorting center and communicably coupled to the communications network 106. In some embodiments, the sorting center device 122 is a handheld device, a smartphone, a tablet device, a computer device, a radio transceiver, a laptop computer, a desktop computer, a smartwatch, or any of various combinations thereof. A drive-through store device 126 is associated with a drive-through store and communicably coupled to the communication network 106. In some embodiments, the drive-through store device 126 is a handheld device, a smartphone, a tablet device, a computer device, a radio transceiver, a laptop computer, a desktop computer, a smartwatch, or any of various combinations thereof. A customer device 120 is associated with a customer and communicably coupled to the communications network 106. In some embodiments, the customer device 120 is a handheld device, a smartphone, a tablet device, a computer device, a radio transceiver, a laptop computer, a desktop computer, a smartwatch, or any of various combinations thereof. A management center communication device 108 is operatively coupled to the communications network 106. In some embodiments, the management center communication device 108 is a handheld device, a smartphone, a tablet device, a computer device, a radio transceiver, a laptop computer, a desktop computer, a smartwatch, or any of various combinations thereof.

The management center communication device 108 is configured for receiving an arrival notification from the driver device 124. The centralized server 102 is configured for generating a driver identification request for the delivery driver based on the arrival notification. The management center communication device 108 is further configured for transmitting the driver identification request to the driver device 124, and receiving a driver identifier associated with the delivery driver from the driver device 124. The centralized server 102 is further configured for authenticating the driver based on the driver identifier. The driver device 124 is further configured for receiving a package collecting notification, including a package identifier that uniquely identifies a package, from the sorting center device 122. At least one of the driver device 124 or the drive-through store device 126 is further configured for identifying the package based on the package identifier. The management center communication device 108 is further configured for receiving a package unloading notification including the package identifier from the drive-through store device 126. The centralized server 102 is further configured for generating a package availability notification including the package identifier based on the package unloading notification. The management center communication device 108 is further configured for transmitting the package availability notification to the customer device 120 and receiving a customer identifier from the customer device 120. The centralized server 102 is further configured for authenticating the customer based on the customer identifier, and identifying the package associated with the customer based on the authenticating.

In some embodiments, a user of the online platform 100 such as the delivery driver, the customer, a sorting center employee, a drive-through store employee, and/or a management center employee, may access the online platform 100 through a web-based software application, a smartphone application, a browser, or any of various combinations thereof. The web-based software application may be embodied, for example, using a website, a web application, a desktop application, and/or a mobile application compatible with a smartphone or tablet device.

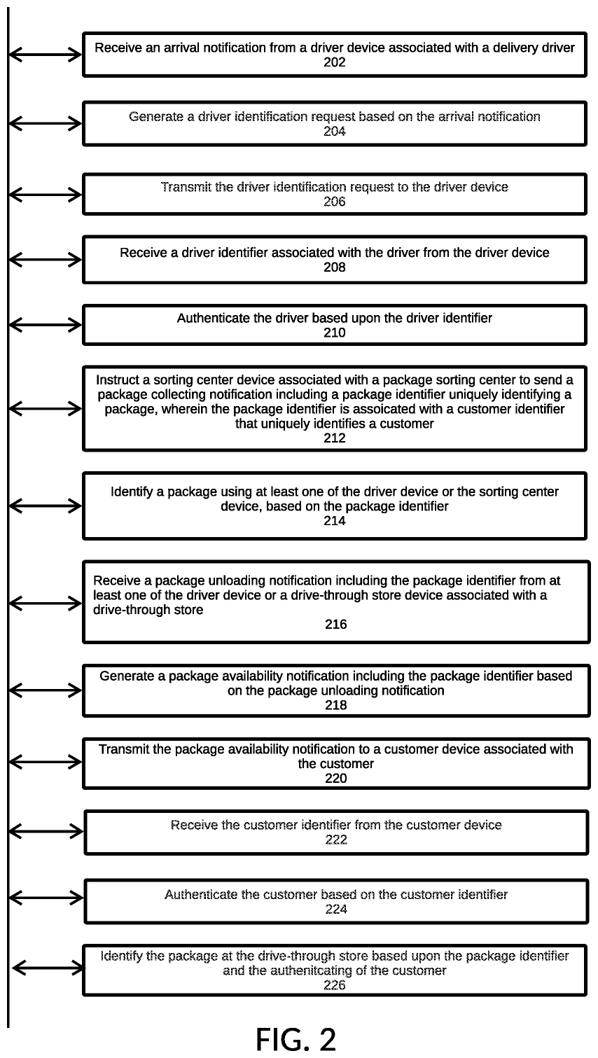

FIG. 2 is a flowchart of a method for facilitating management of package deliveries, in accordance with some embodiments. One example embodiment provides a method that includes at least one of: receiving an arrival notification from a driver device associated with a delivery driver (block 202); generating a driver identification request based on the arrival notification (block 204); transmitting the driver identification request to the driver device (block 206); receiving a driver identifier associated with the driver from the driver device (block 208); authenticating the driver based on the driver identifier (block 210); instructing a sorting center device associated with a package sorting center to send a package collecting notification including a package identifier uniquely identifying a package, wherein the package identifier is associated with a customer identifier that uniquely identifies a customer (block 212); identifying a package using at least one of the driver device or the sorting center device, based on the package identifier (block 214); receiving a package unloading notification including the package identifier from at least one of the driver device or a drive-through store device associated with a drive-through store (block 216); generating a package availability notification including the package identifier based on the package unloading notification (block 218); transmitting the package availability notification to a customer device associated with the customer (block 220); receiving the customer identifier from the customer device (block 222); authenticating the customer based on the customer identifier (block 224); and identifying the package at the drive-through store based on the package identifier and the authenticating of the customer (block 226).

In some embodiments, the arrival notification may include an indication of an arrival of the delivery driver to the sorting center. The sorting center is used to hold one or more packages. The delivery driver may include any individual that engages in at least one activity associated with the delivery of the package. In some embodiments, the driver identifier may include a driver's name, a drivers' license number, a date of birth, an address, one or more physical characteristics such as height, weight, eye color and/or hair color, or any of various combinations thereof. The package collecting notification indicates that the package may be ready for collecting from the sorting center by the delivery driver. The delivery driver may employ a deliver vehicle equipped with a carrier mechanism that may be used for transporting the package. The package collecting notification may include at least one package identifier. The at least one package identifier may include a package's name, a package's identification number, a package's type, etc. The package identifier uniquely identifies the package.

In some embodiments, the package may be loaded into the driver vehicle associated with the delivery driver from the sorting center for facilitating a delivery of the package based on the identifying of the package. The package unloading notification indicates an unloading of the package into the drive-through store. The package unloading notification may include the package identifier. The package may be unloaded into the drive-through store from the driver vehicle for facilitating the delivery of the package. The driver may transport the package between the sorting center and the drive-through store. The drive-through store may be configured for temporarily holding the package. Further, the package may be stored in the drive-through store in an arrangement that is based on the package identifier of the package. The package availability notification indicates an availability of the package to the customer in the drive-through store. The package may be delivered to the customer from the drive-through store. Alternatively or additionally, the package may be placed on at least one curbside of the at least drive-through store for facilitating the delivery of the package to the customer.

In some embodiments, the sorting center may include at least one loading device. The at least one loading device may be configured for loading the package into the driver vehicle associated with the driver. The loading of the package into the driver vehicle facilitates the delivery of the package.

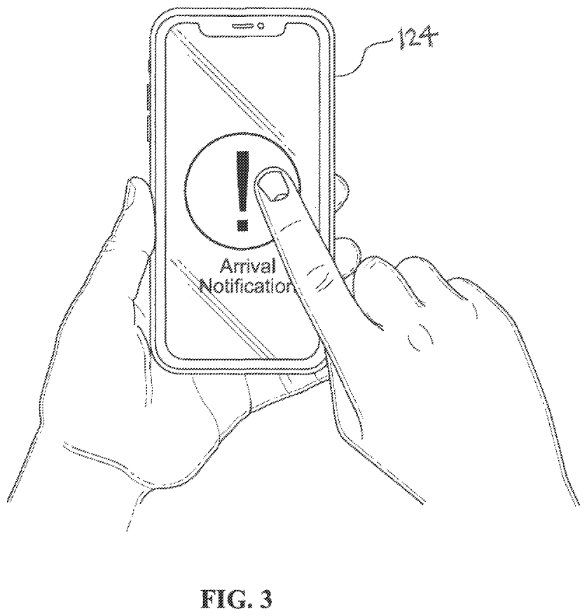

FIG. 3 illustrates the sending of the arrival notification from the driver device 124 for facilitating the management of package deliveries, in accordance with some embodiments. For further details regarding the sending of the arrival notification, refer to block 202 of FIG. 2.

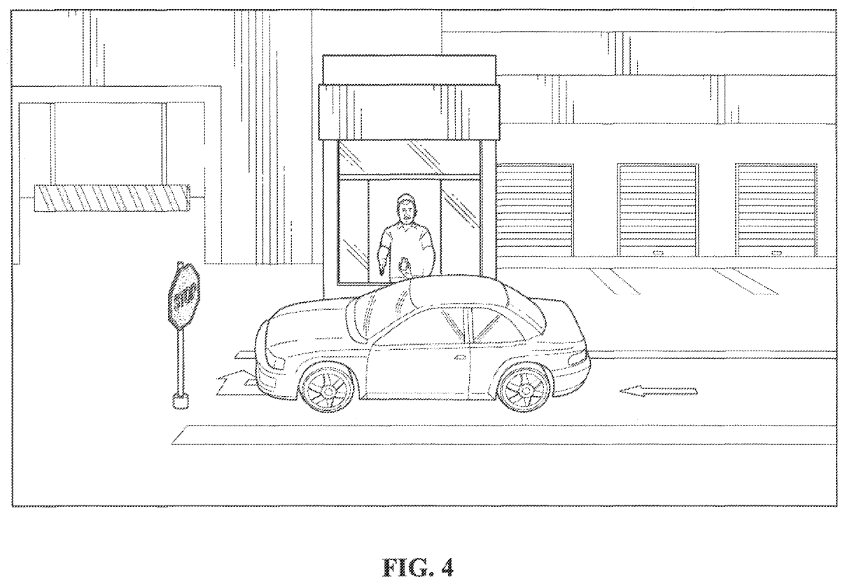

FIG. 4 illustrates verification of a driver by the centralized server 102 (FIG. 1) when the driver arrives at the sorting center. This process is also described at blocks 210-214 of FIG. 2.

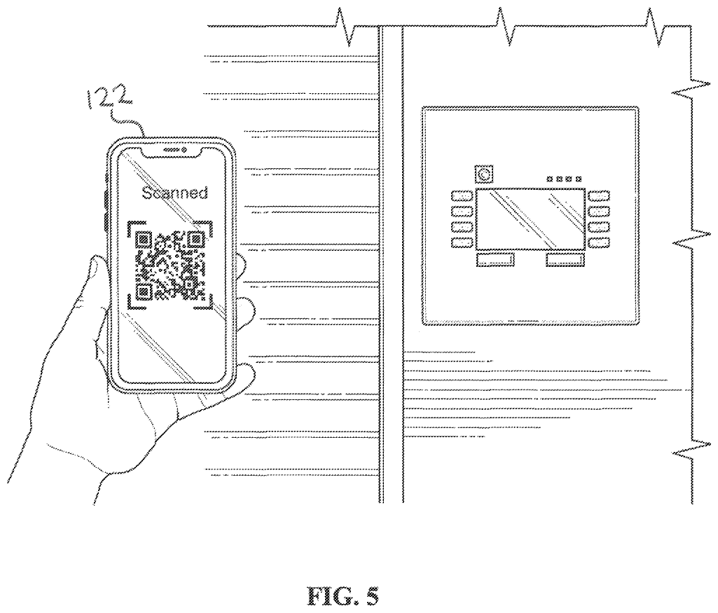

FIG. 5 illustrates scanning of a barcode of a package on the sorting center device 122 of the sorting center. This process is performed so as to enable the sorting center device 122 to provide the package collecting notification described previously at blocks 212-214 (FIG. 2).

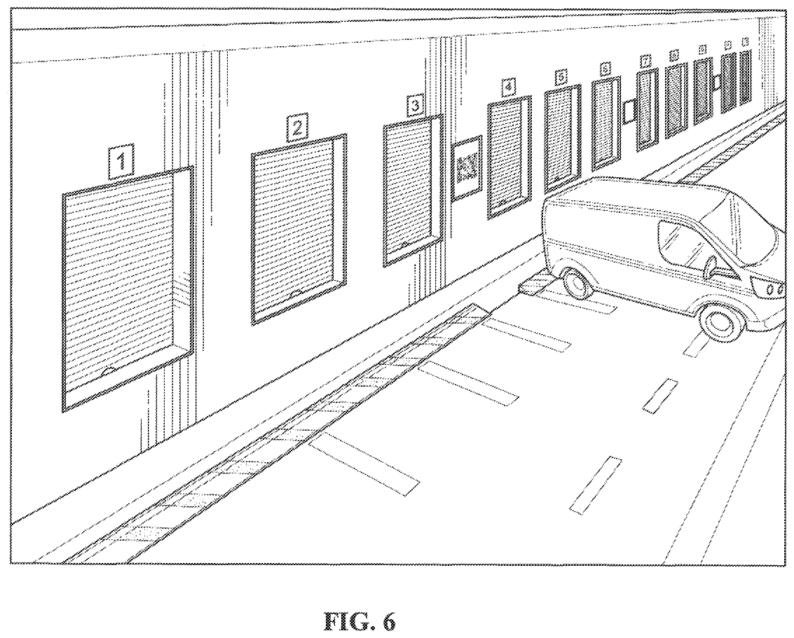

FIG. 6 illustrates a loading process for facilitating the management of package deliveries, in accordance with some embodiments.

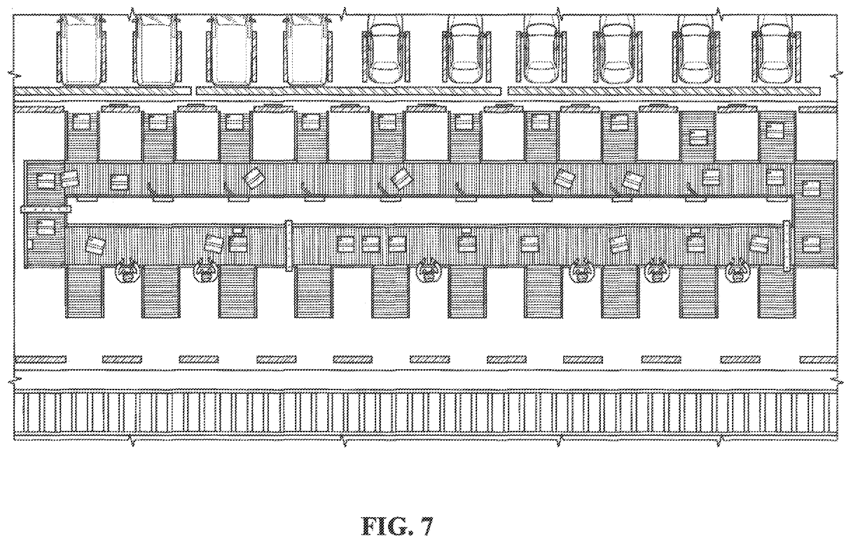

FIG. 7 illustrates a procedure for arranging packages in the sorting center for facilitating the management of package deliveries, in accordance with some embodiments.

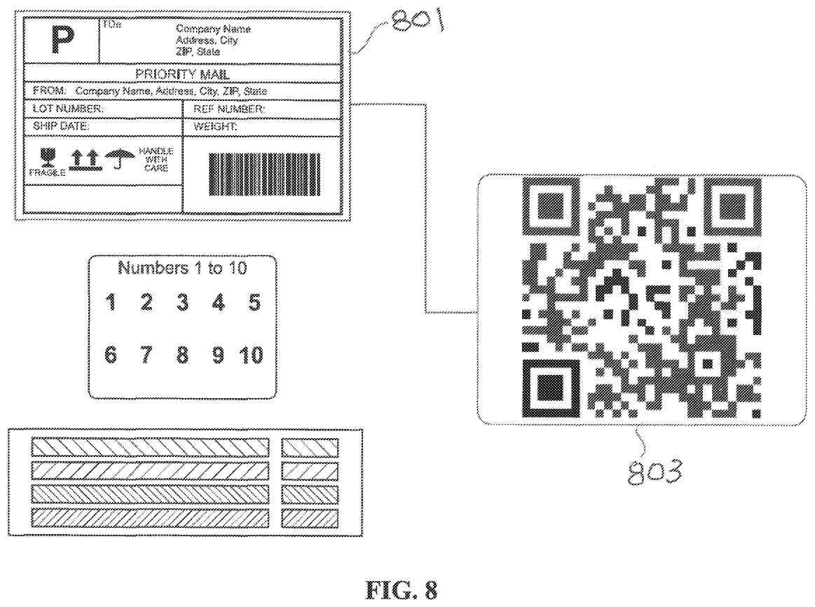

FIG. 8 illustrates a package label 801 that is affixed to the package in order to facilitate the management of package deliveries. In some embodiments, the package label 801 may include a destination name and address, an originating name and address, a bar code, a shipping date, a shipping weight, or any of various combinations thereof. Alternatively or additionally, in accordance with some embodiments, the label may include a Quick Response (QR) code 803.

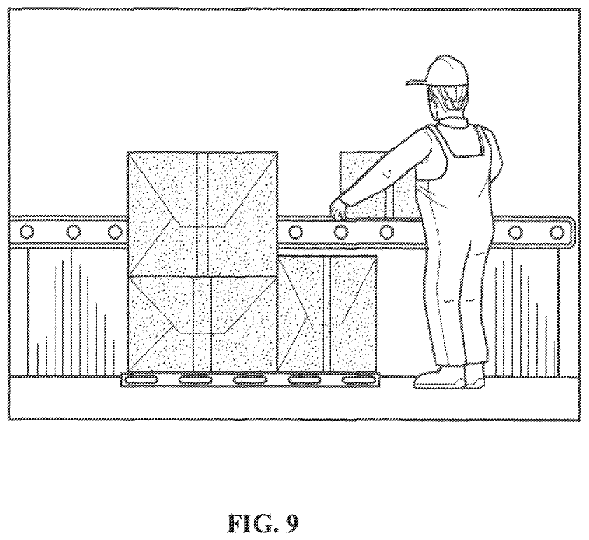

FIG. 9 illustrates a loading procedure for the package in order to facilitate the management of package deliveries, in accordance with some embodiments.

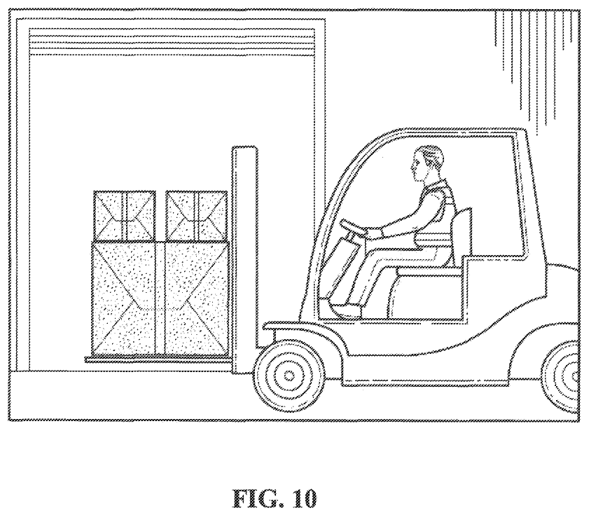

FIG. 10 illustrates a loading procedure for the package in order to facilitate the management of package deliveries, in accordance with some embodiments.

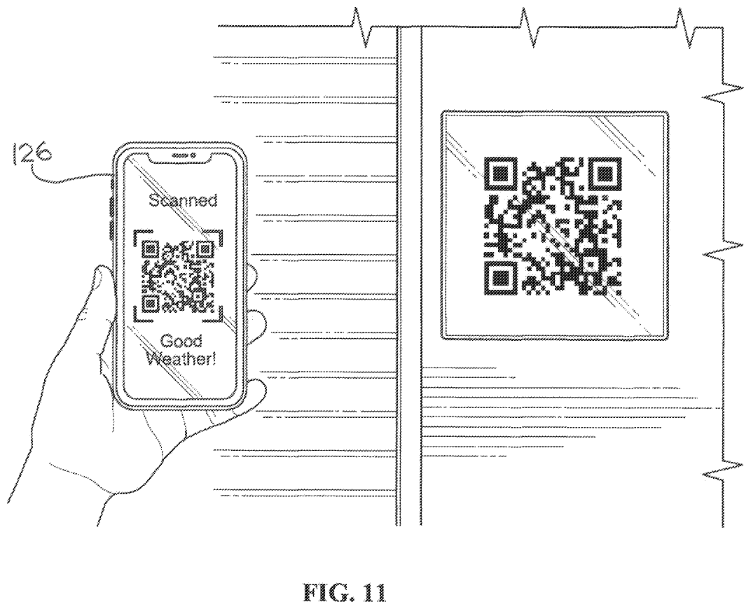

FIG. 11 illustrates an unloading procedure for unloading the package to the drive-through store. Incoming packages that are unloaded at the drive-through store are scanned by the drive-through store device 126 (FIG. 1).

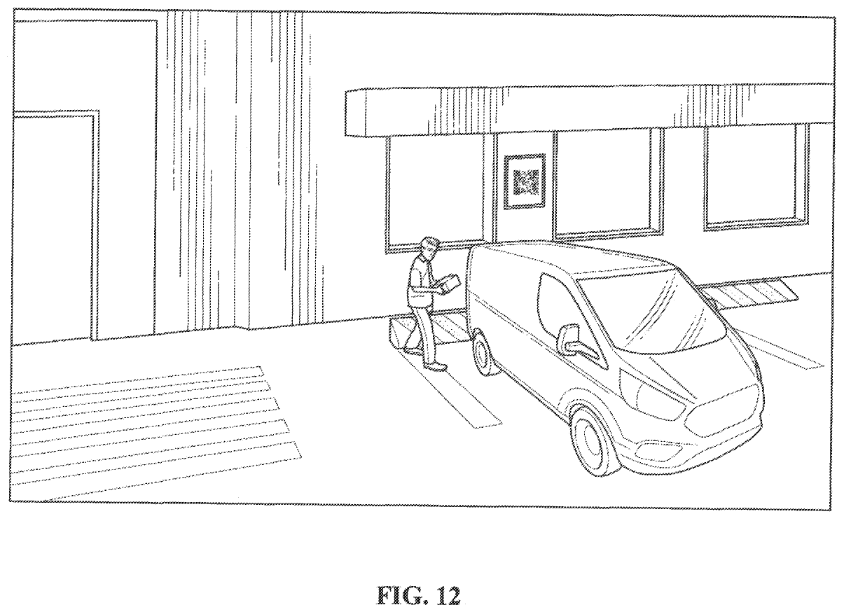

FIG. 12 illustrates a package unloading procedure for unloading packages from a vehicle in order to facilitate the management of package deliveries, in accordance with some embodiments.

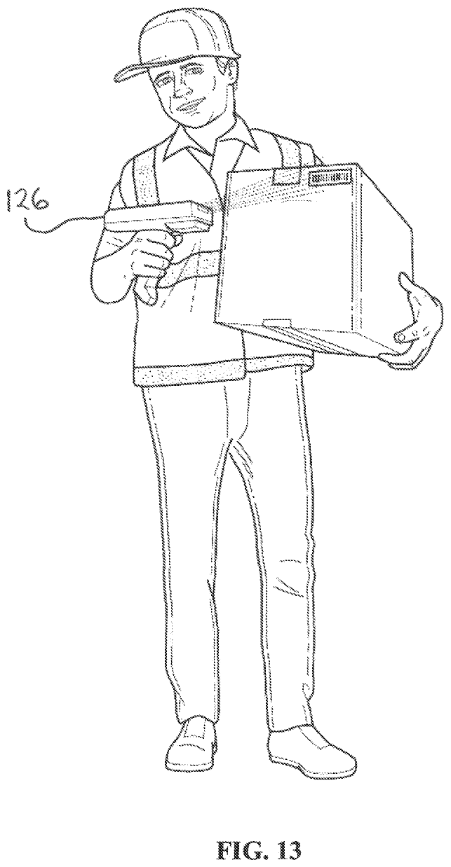

FIG. 13 illustrates a package scanning, signing, and arrangement procedure at the drive-through store for facilitating the management of package deliveries, in accordance with some embodiments. A drive-through store employee uses the drive-through store device 126 to scan all incoming and outgoing packages at the drive-through store.

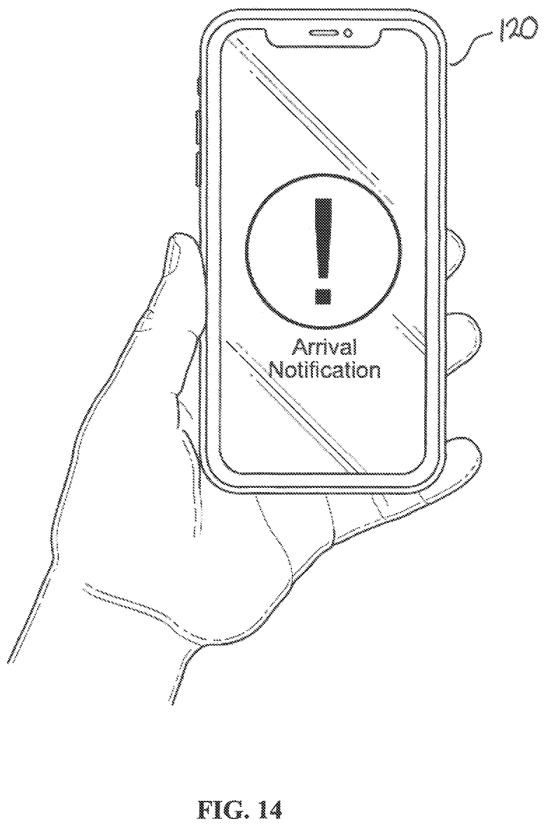

FIG. 14 illustrates transmitting of the package availability notification to customers for facilitating the management of package deliveries, in accordance with some embodiments. The package availability notification, previously discussed in connection with block 220 (FIG. 2), is sent to the customer device 120 (FIG. 1). The package availability notification informs the customer that their package has arrived at the sorting center and/or the drive-through store and is ready for the customer to pick up.

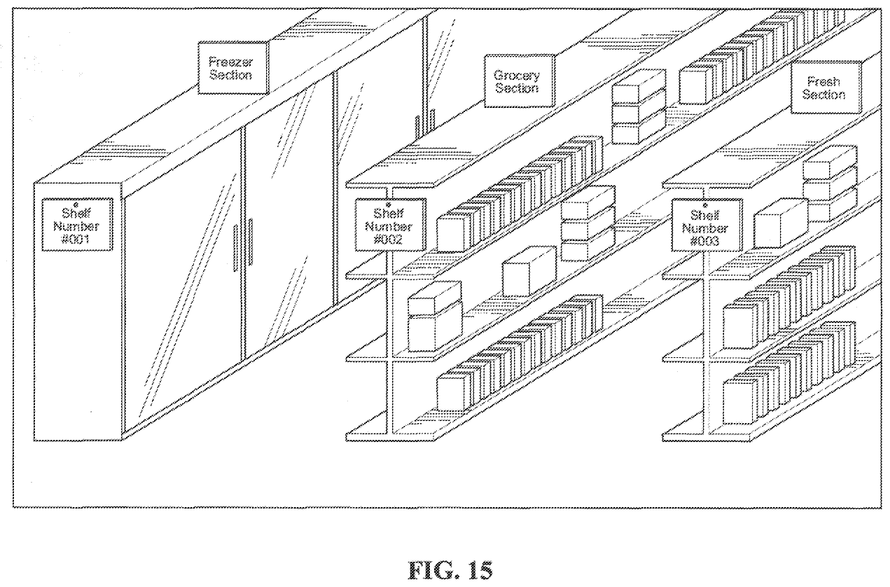

FIG. 15 illustrates a package arrangement procedure inside the drive-through store for facilitating the management of package deliveries, in accordance with some embodiments. A first shelf, designated as shelf number 001, is used to store items that must be kept frozen. A second shelf, designated as shelf number 002, is used to store grocery items. A third shelf, designated as shelf number 003, is used to store produce and other fresh food items. These categorizations are provided solely for illustrative purposes, as other methods of shelf organization may be utilized.

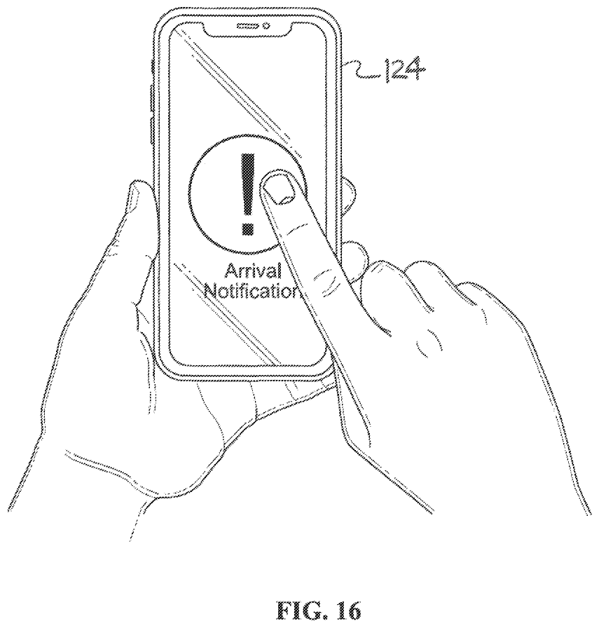

FIG. 16 illustrates driver pickup procedures from the drive-through store for facilitating the management of package deliveries, in accordance with some embodiments. The arrival notification, previously discussed in connection with block 202 (FIG. 2), is sent by the driver device 124 (FIG. 1).

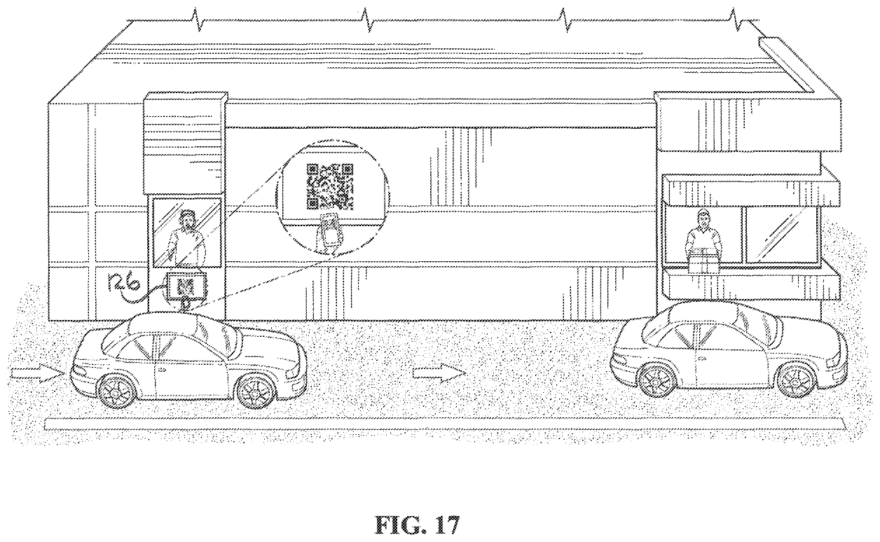

FIG. 17 illustrates a package pickup and drop off procedure at the drive-through store for facilitating the management of package deliveries, in accordance with some embodiments. Incoming and outgoing packages are scanned by the drive-through store scanner 126.

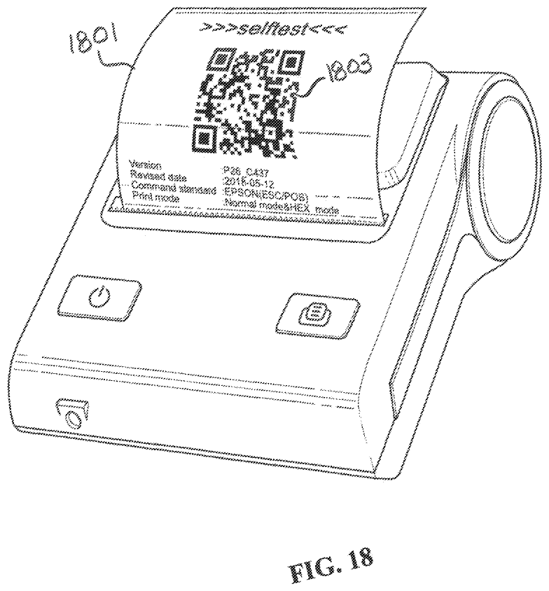

FIG. 18 illustrates printing of a receipt 1801 for facilitating the management of package deliveries. In some embodiments, the receipt 1801 includes a QR code 1803.

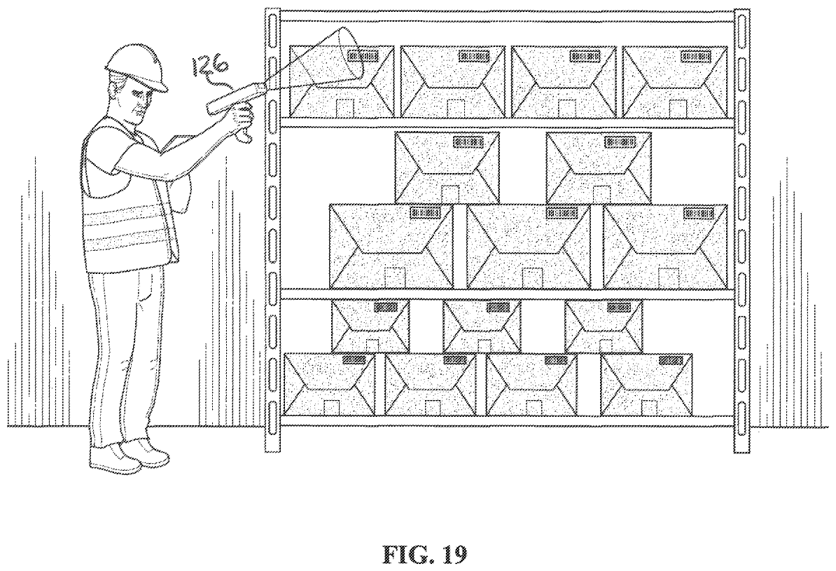

FIG. 19 illustrates a procedure for locating packages placed in the drive-through store in order to facilitate the management of package deliveries, in accordance with some embodiments. The drive-through store device 126 is used by a drive-through store employee to scan one or more packages in order to locate a desired package.

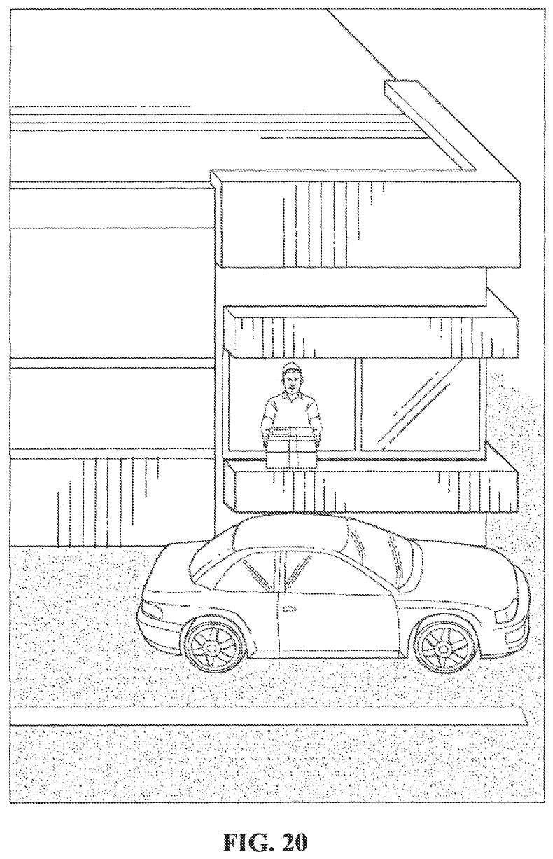

FIG. 20 illustrates delivery of the package to the driver or the customer for facilitating the management of package deliveries, in accordance with some embodiments.

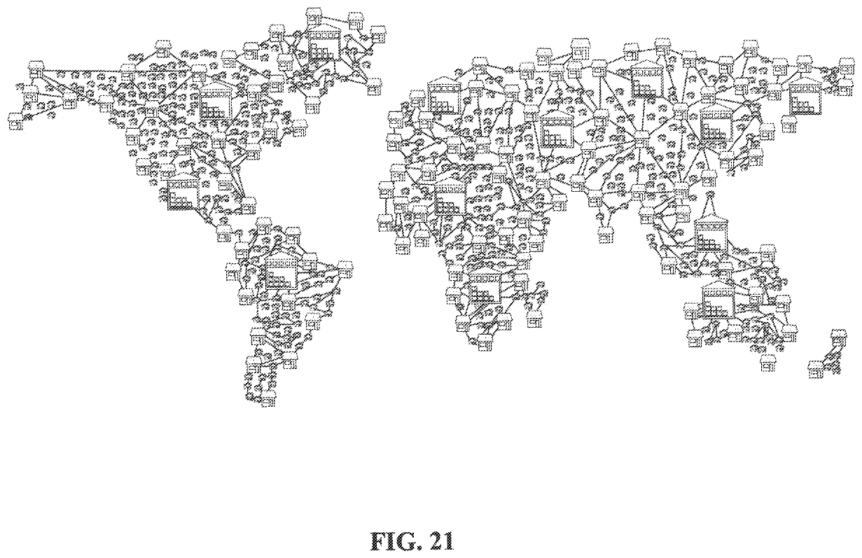

FIG. 21 illustrates an exemplary placement of a plurality of sorting centers and drive-through stores throughout the world for facilitating the management of package deliveries, in accordance with some embodiments. In other embodiments, the sorting centers and drive-through stores are provided within the United States.

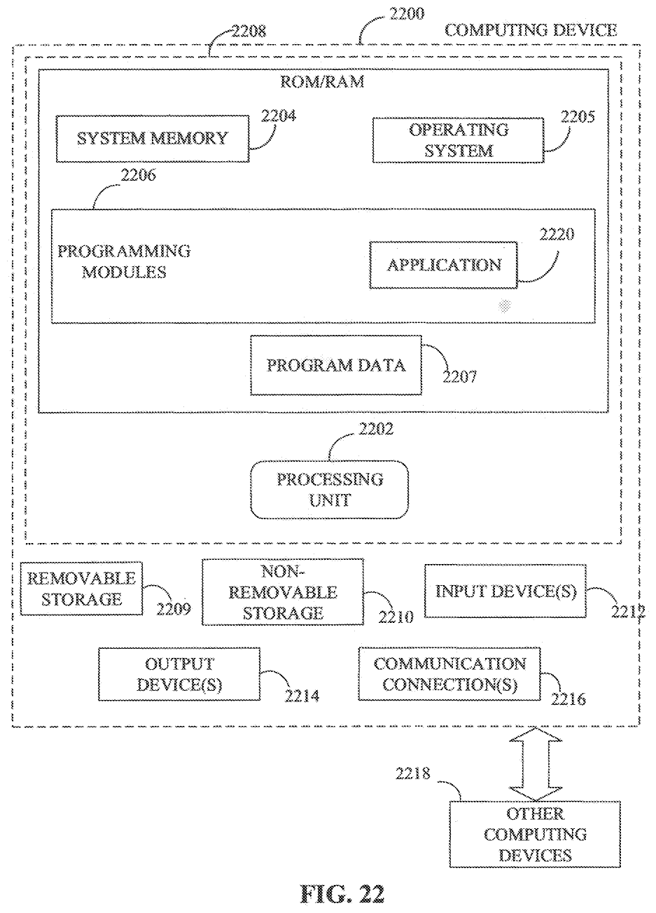

With reference to FIG. 22, a system consistent with an embodiment of the disclosure may include a computing device or cloud service, such as the computing device 2200. In a basic configuration, the computing device 2200 may include at least one processing unit 2202 and a system memory 2204. Depending on the configuration and type of computing device 2200, system memory 2204 may comprise, but is not limited to, volatile (e.g. random-access memory (RAM)), non-volatile (e.g. read-only memory (ROM)), flash memory, or any combination. The system memory 2204 may include operating system 2205, one or more programming modules 2206, and may include a program data 2207. The operating system 2205, for example, may be suitable for controlling the operation of the computing device 2200. Furthermore, embodiments of the disclosure may be practiced in conjunction with a graphics library, other operating systems, or any other application program and is not limited to any particular application or system. This basic configuration is illustrated in FIG. 22 by those components within a dashed line 2208.

In some embodiments, the computing device 2200 may have additional features or functionality. For example, the computing device 2200 may also include additional data storage devices (removable and/or non-removable) such as, for example, magnetic disks, optical disks, or tape. Such additional storage is illustrated in FIG. 22 by a removable storage 2209 and a non-removable storage 2210. Computer storage media may include volatile and nonvolatile, removable and non-removable media implemented in any method or technology for storage of information, such as computer-readable instructions, data structures, program modules, or other data. System memory 2204, removable storage 2209, and non-removable storage 2210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 2200. Any such computer storage media may be part of device 2200.

The computing device 2200 may also have one or more input device(s) 2212 such as a keyboard, a mouse, a pen, a sound input device, a touch input device, a location sensor, a camera, a biometric sensor, etc. Output device(s) 2214 such as a display, speakers, a printer, etc. may also be included. The aforementioned devices are examples and others may be used. The computing device 2200 may also contain a communication connection 2216 that may allow device 2200 to communicate with other computing devices 2218, such as over a network in a distributed computing environment, for example, an intranet or the Internet. The communication connection 2216 is one example of communication media.

Communication media may typically be embodied by computer-readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer-readable media as used herein may include both storage media and communication media.

As stated above, a number of program modules and data files may be stored in system memory 2204, including operating system 2205. While executing on processing unit 2202, programming modules 2206 (e.g., application 2220 such as a media player) may perform processes including, for example, one or more stages of methods, algorithms, systems, applications, servers, databases as described above. The aforementioned process is an example, and processing unit 2202 may perform other processes. Other programming modules that may be used in accordance with embodiments of the present disclosure may include sound encoding/decoding applications, machine learning application, acoustic classifiers, etc. Generally, consistent with embodiments of the disclosure, program modules may include routines, programs, components, data structures, and other types of structures that may perform particular tasks or that may implement particular abstract data types.

Embodiments of the disclosure may be practiced with other computer system configurations, including hand-held devices, general-purpose graphics processor-based systems, multiprocessor systems, microprocessor-based or programmable consumer electronics, application-specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer-readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid-state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the invention has been explained in relation to its preferred embodiment, it is to be understood that many other possible modifications and variations can be made without departing from the spirit and scope of the invention.

What is claimed is:

1. A method, comprising:
receiving an arrival notification from a driver device associated with a delivery driver;
generating a driver identification request based on the arrival notification;
transmitting the driver identification request to the driver device;
receiving a driver identifier associated with the driver from the driver device;
authenticating the driver based on the driver identifier;
instructing a sorting center device associated with a package sorting center to send a package collecting notification to the driver device, the package collecting notification including a package identifier for uniquely identifying a package, wherein the package identifier is associated with a customer identifier for uniquely identifying a customer;
identifying the package using at least one of the driver device or the sorting center device, based on the package identifier;
receiving a package unloading notification including the package identifier from at least one of the driver device or a drive-through store device associated with a drive-through store;
generating a package availability notification including the package identifier based on the package unloading notification;
transmitting the package availability notification to a customer device associated with the customer;
receiving a customer identifier uniquely identifying the customer from the customer device;
authenticating the customer based on the customer identifier; and
identifying the package at the drive-through store based upon the package identifier and the authenticating of the customer.

2. The method of claim 1, wherein the identifying of the package using at least one of the driver device or the sorting center device further comprises scanning a label on the package, the label including the package identifier.

3. The method of claim 1, wherein the identifying of the package based on the package identifier and the authenticating further comprising scanning a label on the package using the customer device, the label including the package identifier.

4. The method of claim 1, further comprising generating the package unloading notification using at least one of the driver device or the drive-through store device in response to the package being dropped off at the drive-through store.

5. The method of claim 1, further comprising using a terrestrial transportation vehicle to transport the package from the sorting center to the drive-through store in response to the identifying of the package using at least one of the driver device or the sorting center device.

6. The method of claim 1, further comprising receiving a delivery confirmation from the customer device, the delivery confirmation being generated by the customer device in response to the package being delivered to the customer and scanned by the customer device.

7. A system for facilitating management of a package delivery, the system comprising:
a centralized server operatively coupled to a computer-readable storage medium;
a communications network communicably coupled to the centralized server;
a driver device associated with a delivery driver and communicably coupled to the communications network;
a sorting center device associated with a delivery sorting center and communicably coupled to the communications network;
a drive-through store device associated with a drive-through store and communicably coupled to the communications network;
a customer device associated with a customer and communicably coupled to the communication network; and
a management center communication device operatively coupled to the communication network;
wherein the management center communication device is configured for receiving an arrival notification from the driver device;
wherein the centralized server is configured for generating a driver identification request for the delivery driver based on the arrival notification;
wherein the management center communication device is further configured for transmitting the driver identification request to the driver device, and receiving a driver identifier associated with the delivery driver from the driver device;
wherein the centralized server is further configured for authenticating the driver based on the driver identifier;
wherein at least one of the centralized server or the management communication device is configured for instructing the sorting center device to send a package collecting notification including a package identifier for uniquely identifying the package to the driver device; wherein the package identifier is associated with a customer identifier for uniquely identifying the customer;
wherein at least one of the driver device or the sorting center device is further configured for identifying the package based on the package identifier;
wherein the management center communication device is further configured for receiving a package unloading notification, including the package identifier, from at least one of the driver device or the drive-through store device;
wherein the centralized server is further configured for generating a package availability notification including the package identifier, based on the package unloading notification; and
wherein the management center communication device is further configured for transmitting the package availability notification to the customer device and receiving the customer identifier from the customer device.

8. The system of claim 7, wherein the centralized server is further configured for authenticating the customer based on the customer identifier.

9. The system of claim 8, wherein at least one of the centralized server, the drive-through store device, or the customer device is configured for identifying the package at the drive-through store based on the package identifier and the authenticating of the customer.

10. The system of claim 7, wherein at least one of the driver device or the sorting center device is further configured to identify the package at the sorting center by scanning a label on the package, wherein the label includes the package identifier.

11. The system of claim 7, wherein at least one of the driver device or the drive-through store device are further configured for generating the package unloading notification in response to the package being dropped off at the drive-through store.

12. The system of claim 7, further comprising a terrestrial transportation vehicle configured to transport the package from the sorting center to the drive-through store in response to the identifying of the package at the sorting center.

13. The system of claim 7, wherein the management center communication device is further configured to receive a delivery confirmation generated by the customer device in response to the package being delivered to the customer and scanned by the customer device.

14. A computer-readable storage medium comprising instructions that, when read by a processor, cause the processor to perform:
receiving an arrival notification from a driver device associated with a delivery driver;
generating a driver identification request based on the arrival notification;
transmitting the driver identification request to the driver device;
receiving a driver identifier associated with the driver from the driver device;
authenticating the driver based on the driver identifier;
instructing a sorting center device associated with a package sorting center to send a package collecting notification to the driver device, the package collecting notification including a package identifier for uniquely identifying a package, wherein the package identifier is associated with a customer identifier for uniquely identifying a customer;
identifying the package using at least one of the driver device or the sorting center device, based on the package identifier;
receiving a package unloading notification including the package identifier from at least one of the driver device or a drive-through store device associated with the drive-through store;
generating a package availability notification including the package identifier based on the package unloading notification;
transmitting the package availability notification to a customer device associated with the customer;
receiving a customer identifier uniquely identifying the customer from the customer device;
authenticating the customer based on the customer identifier; and
identifying the package at the drive-through store based upon the package identifier and the authenticating of the customer.

15. The computer-readable storage medium of claim 14, further comprising instructions for scanning a label on the package using at least one of the drive-through store device, the sorting center device, the customer device, or the driver device, the label including the package identifier.

16. The computer-readable storage medium of claim 14, further comprising instructions for generating the package unloading notification using at least one of the driver device or the drive-through store device in response to the package being dropped off at the drive-through store.

17. The computer-readable storage medium of claim 14, wherein a terrestrial transportation vehicle is used to transport the package from the sorting center to the drive-through store in response to the identifying of the package using at least one of the driver device or the sorting center device.

18. The computer-readable storage medium of claim 14, further comprising instructions for receiving a delivery confirmation from the customer device, the delivery confirmation being generated by the customer device in response to the package being delivered to the customer and scanned by the customer device.
